(19) United States
(12) Patent Application Publication
(10) Pub. No.: US 2016/0303605 A1
(43) Pub. Date: Oct. 20, 2016

(54) COATING SYSTEM AND METHOD

(71) Applicant: 3M INNOVATIVE PROPERTIES COMPANY, St. Paul, MN (US)

(72) Inventors: Clinton L. Jones, Somerset, WI (US); Shawn R. Sweeney, New Brunswick (CA); Scott M. Fabozzi, Lino Lakes, MN (US); Cori S. Griesgraber, Woodbury, MN (US); Ryan B. Prince, St. Paul, MN (US); Carson MacCallum, Ontario (CA)

(21) Appl. No.: 14/782,443

(22) PCT Filed: Apr. 4, 2014
(86) PCT No.: PCT/US14/32958

§ 371 Date: Oct. 5, 2015

Related U.S. Application Data
(60) Provisional application No. 61/809,674, filed on Apr. 8, 2013.

(51) Int. Cl. B05B 13/06; F16L 58/10; B05D 1/02

(52) U.S. Cl. CPC B05B 13/06; B05D 1/02; F16L 58/1027

(57) ABSTRACT

A portable delivery system for delivering a multiple part coating composition for in situ coating an internal pipeline surface comprises a housing including a controller, at least two composition containers, a first hose, a hose delivery system, a pump, and at least two mass flow meters. The composition containers contain differing compositions, and each container includes a composition depth monitoring apparatus. The first hose comprises at least two additional hoses, where two of the additional hoses each deliver one of the compositions to a composition applicator. The hose delivery system stores and delivers the first hose to the pipeline, and the pump is coupled to the composition containers and the first hose. The mass flow meters are each coupled to a pump outlet corresponding to an outlet of the respective first or second composition container.

### TECHNICAL FIELD

This disclosure relates generally to in-situ pipe coating, and more particularly, to providing high volumetric flow rate composition delivery for portable coating operations.

### BACKGROUND

Infrastructure pipelines that carry fluids such as potable water, gas, sewer, and oil deteriorate over time due to their extensive use. This deterioration can lead to leaks and bursts resulting in costly damage if the pipelines are not maintained. Since these pipelines are typically located underground and provide essential utilities, maintenance and rehabilitation is preferably performed with as minimal disruption to service as possible. Several methods for performing in-situ maintenance and rehabilitation on these pipes, known as trenchless methods, have been developed. One such method involves feeding an applicator device through the pipe to spray a material along the interior surface of the pipe. The material then hardens to form a new, interior liner surface to seal cracks and strengthen the existing pipeline.

### SUMMARY

An embodiment of the present disclosure is directed to a portable delivery system for delivering a multiple part coating composition for in situ coating an internal pipeline surface. The system comprises a housing that comprises a controller, at least two composition containers, a first hose, a hose delivery system, a pump, and at least two mass flow meters. The at least two composition containers include a first and a second composition container which are configured to contain differing compositions, and each container includes a composition depth monitoring apparatus. The first hose has a first diameter and comprises at least two additional hoses, a first and a second additional hose each having a diameter smaller than the first diameter, located within the first hose, and configured to deliver one of the at least two compositions to a composition applicator. The hose delivery system is configured to store and deliver the first hose to the pipeline, and the pump is coupled to the at least two composition containers and the first hose. The at least two mass flow meters include a first mass flow meter coupled to a first pump outlet corresponding to an outlet of the first composition container and a second mass flow meter coupled to a second pump outlet corresponding to an outlet of the second composition container.

Another embodiment is directed to a portable delivery system for delivering a multiple part coating composition for in situ coating an internal pipeline surface. The system comprises a housing including a controller, at least two composition containers configured to contain differing compositions, a first hose, a hose delivery system, and a pump. The first hose has a first diameter and comprises at least six additional hoses each having a diameter smaller than the first diameter and located within the first hose. Two of the at least six additional hoses are configured to deliver a respective one of the at least two compositions to a composition applicator. The hose delivery system is configured to store and deliver the first hose to the pipeline, and the hose delivery system comprises at least six ports. The pump is coupled to the at least two composition containers and the first hose.

A further embodiment is directed to a method for initiating delivery of a two part coating composition for in situ coating an internal pipeline surface. The method includes pulling a distal end of an umbilical hose comprising a first and a second composition supply hose from a lining rig through the pipeline and attaching a composition applicator to the distal end. The umbilical hose includes at least two taps, a first tap coupled to the first composition supply hose and a second tap coupled to the second composition supply hose. Operation of the lining rig is initiated by delivering a first composition to the composition applicator via the first composition supply hose and delivering a second composition to the composition applicator via the second composition supply hose. Next, the composition applicator is actuated by actuating the first and second taps. The first and second compositions are combined in the composition applicator. The method further includes applying the combined first and second compositions to the internal pipeline circumferential surface at a thickness of at least 5 mm to 183 m (600 ft.) of pipeline in a single pass.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

The following figure descriptions are presented in connection with various embodiments of the disclosure.

FIG. 1 is a top-down view of a coating system, in accordance with various embodiments;

FIG. 2A is an external side view of a coating system incorporated in a vehicle, in accordance with various embodiments;

FIG. 2B is an external side view of a coating system incorporated in a trailer, in accordance with various embodiments;

FIG. 3A is a cross-section of a coating system, in accordance with various embodiments;

FIG. 3B is an external side view of a coating system, in accordance with various embodiments;

FIG. 4 is a rear view of a coating system, in accordance with various embodiments;

FIG. 5 is a cross section of a delivery hose, in accordance with various embodiments;

FIG. 6 is a schematic diagram of the composition flows in the coating system, in accordance with various embodiments; and

FIG. 7 is a flow diagram of a method, in accordance with various embodiments.

### DETAILED DESCRIPTION

Infrastructure pipelines, carrying potable water, gas, sewer, and oil, are buried within our communities. These pipelines can be potentially greater than 0.6 m (2 ft.) in diameter and over 152 m (500 ft.) in length. Due to the advancement in chemistries providing increased mechanical properties while maintaining safety certifications (e.g., for potable drinking water), it is possible to coat up to an 8.5 mm lining caliper on 0.6 m (2 ft.) diameter pipe. However, coating systems for maintaining and/or rehabilitating these pipelines must be transported to these project sites.

Traditional portable coating systems include storage for each part of a multi-part coating composition, an umbilical hose to extend to the end of the project pipeline, and the ability to deliver each composition part to the end of the umbilical hose. However, traditional multi-part coating composition application systems are insufficient to provide the increased volume of coating compositions required for higher caliper lining and/or larger diameter pipeline projects along with the application speeds desired for same day return to service (e.g., completing a maintenance/rehabilitation coating application and returning the pipeline to active service within the same day). Coating systems according to various embodiments described herein address these issues and further provide for increased operator safety, additional operator oversight, and increased composition mix ratio accuracy. In addition, for economic reasons, higher volume and higher speed coating applications benefit from increased efficiency in composition usage. The described coating systems include advanced equipment and logic components for safer application of corrosive chemistries.

An important factor influencing the final pipe coating caliper and integrity is the composition chemistry. For example, fast setting, high viscosity, statically mixed, polyurea coating chemistries harden to at least a tack-free state in less than thirty seconds once applied to the interior surface of a pipe (or to portions of the coating applicator). These chemistries are typically two-part chemistries including a first part comprising one or more aliphatic polyisocyanates, optionally blended with one or more amine reactive resins and/or non-reactive resins and a second part comprising one or more polyamines optionally blended with one or more oligomeric polyamines. The two parts, when mixed together and applied to the internal surfaces of pipelines, form a rapid setting impervious coating suitable for contact with drinking water.

The first part aliphatic polyisocyanate(s) may be any organic isocyanate compound containing at least two isocyanate functional groups, said isocyanate groups being aliphatic in nature. Suitable polyisocyanates include hexamethylene-1,6-diisocyanate; 2,2,4-trimethylhexamethylene diisocyanate; isophorone diisocyanate; and 4,4′-dicyclohexylmethane diisocyanate. Alternatively, reaction products or prepolymers derived from the above may be utilized, such as, polyisocyanate derivatives of hexamethylene-1,6-diisocyanate. The polyisocyanate compounds typically have an isocyanate content of between 5 weight percent (wt %) and 50 wt %, and more specifically, 20-25 wt %. The amine reactive resin(s) of the first part can be any compound containing functional groups which are capable of reacting with primary or secondary amines. Useful materials include epoxy functional compounds and any compounds containing ethylenically unsaturated bonds capable of undergoing “Michael Addition” with polyamines, e.g. monomeric or oligomeric polyacrylates. Non-reactive resins may also be used if they have no adverse effects on water or gas quality during pipe operation.

The second part of the two part coating comprises one or more polyamines. As used herein, polyamine refers to compounds having at least two amine groups, each containing at least one active hydrogen (N—H group) selected from primary amine or secondary amine. In some embodiments, the second component comprises one or more secondary amines. In certain embodiments, the amine component comprises at least one aliphatic cyclic secondary diamine.

In one embodiment, the second part comprises one or more aliphatic cyclic secondary diamines that comprise two, optionally substituted, hexyl groups bonded by a bridging group. Each of the hexyl rings comprises a secondary amine substituent.

The aliphatic cyclic secondary diamine typically has the general structure:

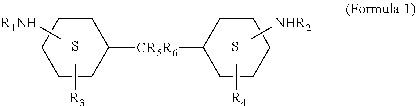

wherein R₁ and R₂ are independently linear or branched alkyl groups, having 1 to 10 carbon atoms. R₁ and R₂ are typically the same alkyl group. Representative alkyl groups include methyl, ethyl, propyl, isopropyl, butyl, isobutyl, secondary butyl, tertiary butyl, and the various isomeric pentyl, hexyl, heptyl, octyl, nonyl, and decyl groups. The symbol “S” in the center of the hexyl rings indicates that these cyclic groups are saturated. The preferred R₁ and R₂ contain at least three carbons, and a butyl group is particularly favored, such as a sec-butyl group.

R₃, R₄, R₅, and R₆ are independently hydrogen or a linear or branched alkyl group containing 1 to 5 carbon atoms. R₃ and R₄ are typically the same alkyl group. In some embodiments, R₅ and R₆ are hydrogen. In some embodiments, R₃ and R₄ are methyl or hydrogen.

The substituents are represented such that the alkylamino group may be placed anywhere on the ring relative to the CR₅R₆ group. Further, the R₃ and R₄ substituents may occupy any position relative to the alkylamino groups. In some embodiments, the alkylamino groups are at the 4,4′-positions relative to the CR₅R₆ bridge. Further, the R₃ and R₄ substituents typically occupy the 3- and 3′-positions.

In another embodiment, the second part comprises one or more aliphatic cyclic secondary diamines that comprise a single hexyl ring. The aliphatic cyclic secondary diamine typically has the general structure:

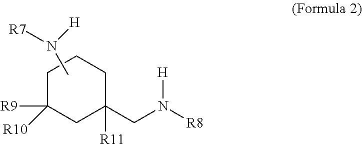

wherein R₇ and R₈ are independently linear or branched alkyl groups, having 1 to 10 carbon atoms or an alkylene group terminating with a —CN group. R₇ and R₈ are typically the same group. Representative alkyl groups include the same as those described above for R₁ and R₂. In one embodiment, R₇ and R₈ are alkyl groups having at least three carbons, such as isopropyl. In another embodiment, R₇ and R₈ are short chain (e.g. C1-C4) alkylene groups, such as ethylene, terminating with a —CN group.

R₉, R₁₀, and R₁₁ are independently hydrogen or a linear or branched alkyl group having 1 to 5 carbon atoms. R₉, R₁₀, and R₁₁ are typically the same alkyl group. In some embodiments, R₉, R₁₀, and R₁₁ are methyl or hydrogen. In one embodiment R₉, R₁₀, and R₁₁ are methyl groups.

The substituents are represented such that the alkylamino group may be placed anywhere on the ring relative to the —NR₈ group. In some embodiments, the alkylamino group is two or three positions away from the —NR₈. The preferred alkylamine group is two positions away from the —NR₈ group on the cyclohexyl ring.

Alternatively the polyamine(s) of the second part may render the composition suitable for coating pipes that transport fluids such as wastewater or natural gas. Exemplary fast setting chemistries that may be employed with the disclosed apparatus and methods are further described in U.S. Pat. Nos. 6,730,353 and 7,189,429 (both to Robinson) and in PCT Publication No. WO 2012/161774 (to Prince et al.). An exemplary commercially available resin is 3M SCOTCHKOTE Pipe Renewal Liner 2400. While the disclosed coating system and methods may be employed with a variety of resin chemistries, substantially uniform coating has been attained for chemistries with tack-free times in the range of 10-90 seconds, and more preferably, less than 30 seconds. More preferably, substantially uniform coating may be attained for chemistries having a tack-free time in a range of 22 to 26 seconds. These relatively fast tack-free times provide for a return-to-service of the pipe approximately two hours after coating is completed.

In addition to chemistries with relatively fast tack-free times as discussed above, compositions with a variety of chemistries and varying tack-free times may be used with disclosed embodiments. For example, polyurethanes including aromatic isocyanates and a polyol may be used.

Prior to applying the above compositions for higher caliper coatings, the compositions are preconditioned in the coating system. Preconditioning involves heating and circulating the thixotropic compositions to induce shear into the coating system thereby decreasing the viscosity of the compositions in the system which allows for better mixing, higher volumetric flow rates and/or lower operating pressures. The coating system includes a valve for each respective composition line to control the flow of the compositions in the system. One valve setting routes the compositions through a short circuit mode which bypasses the umbilical hose and returns the compositions to their respective tanks. This short circuit mode is optional—it may not be used, or even present, in a coating system. A second valve setting is used to open and close a long circuit route which sends the compositions down the umbilical hose and then back to their respective tanks. The long/short circuit valves are located downstream of volumetric flow meters which detect individual composition mix ratios in the tanks.

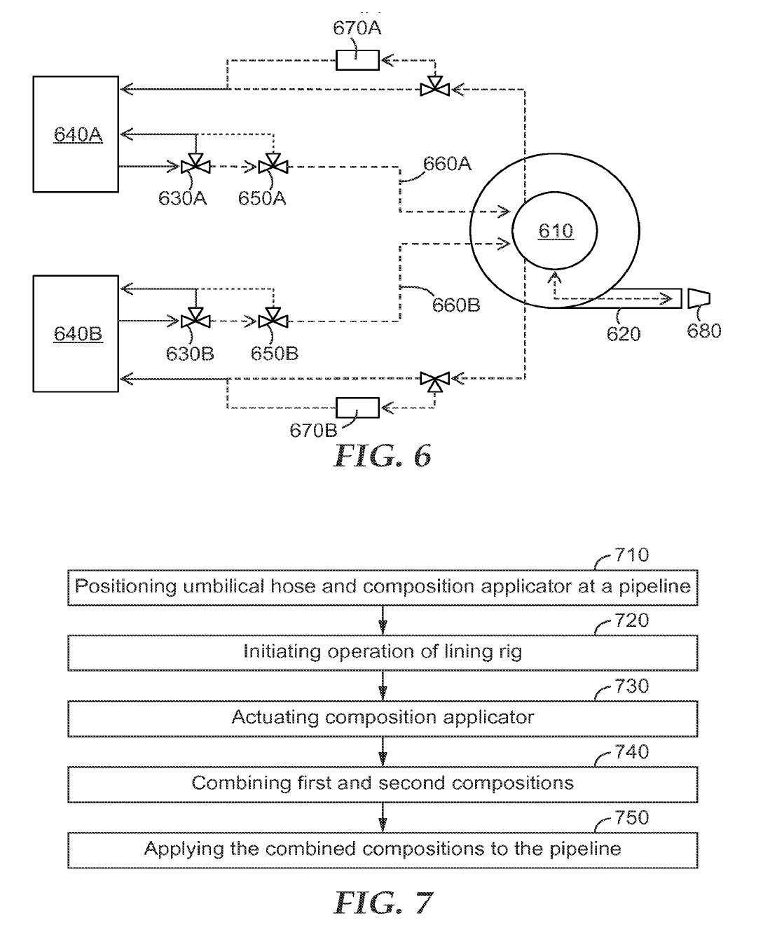

A volumetric mix ratio can be measured precisely at the volumetric flow meter, but depending on the configuration of the short and long circuit valves, be inaccurate at the composition applicator. Additional mass flow meters in the coating system, discussed further below in connection with FIG. 6, compensate for these discrepancies. Adding mass flow meters for each composition in the long circuit return piping, after the umbilical hose but before returning to the storage tanks, provides a redundant mix ratio measurement. The mass flow meter readings can verify that the volumetric flow meters are accurate and that there are no problems with the composition flows in the coating system. Alternatively, if the mass flow meters identify a discrepancy from the volumetric flow measurements when the volumetric or mass readings are known to be accurate, the location of the problem within the system can be identified more quickly. For example, if the volumetric flow readings are off, the source of the problem is likely in the composition lines near the storage tanks. The locations of the mass flow meters provide a proxy measurement for the composition mix ratios at the composition applicator and also satisfy international regulations requiring certain confirmation readings to be taken for coating compositions. Further, the long circuit valves are often left open when the compositions are preconditioned in the short circuit mode. Since resin flow is determined by path of least resistance, this creates a safety concern for operators if an empty umbilical hose is encountered. This tends to occur, for example, after winter cleanouts, but the mass flow meter readings would alert operators with time to close the valves.

The above chemistries are sensitive to environmental contamination and at least one of the compositions is regulated as a hazardous material. Therefore, the composition parts (generally referred to as Part A and Part B of the multi-part coating composition) must be contained to protect both the chemistries and the coating project operators. For example operators wear masks, gloves, and/or protective suits when working with and/or operating the coating system. To improve operator safety, the opportunities for contact with the coating compositions separately, or once mixed together, are preferably reduced. Also, the less pervasive protective gear can be utilized in residential coating projects (e.g., potable water line rehabilitation), the public's confidence in the safety of the materials in their water supply increases.

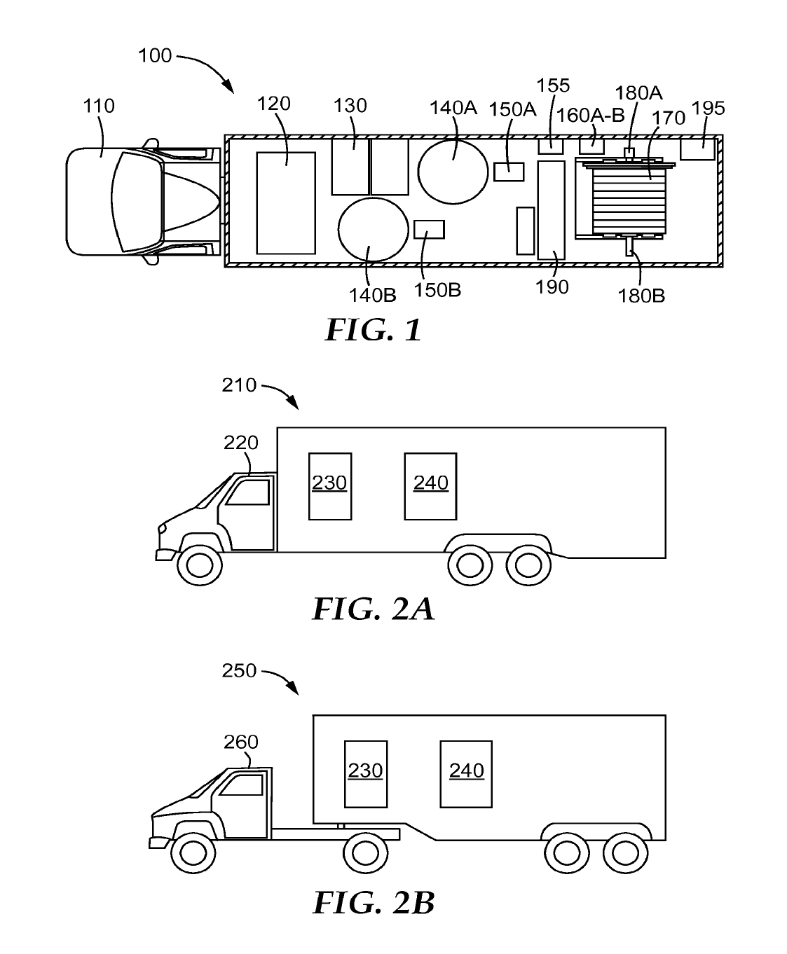

Turning now to FIG. 1, a top-down view of a coating according to embodiments of the disclosure is shown. The coating system 100 is illustrated incorporated into a vehicle 110 such as a truck. The coating system includes a power source 120 such as a generator. For safety reasons and regulations, the power generator 120 operates separately from the power source for the vehicle 110.

Since the coating system is primarily used to apply a two-part coating composition, two storage tanks 140A-B are included. While multi-part compositions can include additional composition parts, additional storage tanks would be included for each composition part. The tanks 140A-B are 1,514 L (400 gal.), 1.95 m (6.4 ft.) tall, and made of stainless steel. Since the composition parts can be water sensitive or corrosive, the tanks 140A-B have lids providing reduced access to the external environment. Tanks 140A-B are illustrated as being the same size, but they can also differ in size to accommodate different coating compositions or vehicle weight requirements.

To prevent excessive operator exposure to the coating chemistries and contamination of the chemistries by frequent opening of the tank lids, each tank 140A-B includes a tank level monitoring system that continuously monitors the composition level in the respective tanks 140A-B. Because the composition parts have high static viscosities and heat transfer within the tanks 140A-B and to the environment is preferably maintained at an even rate, the tanks 140A-B include side-sweeping agitators. Without the side-sweeping agitators, the respective compositions might “body” between an agitator and the tank wall forming a boundary layer that avoids constant mixing thereby altering the overall consistency of the tank composition. However, the side-sweeping blades also eliminate the possibility of using standard tank level probes. While a non-contact measurement technique is preferred, the sizes of the tanks 140A-B require measuring a depth of 1.2-1.5 m (4-5 ft.) from the top of the tanks 140A-B. Laser measurement systems are known to be accurate in the 0.6-0.9 m (2-3 ft.) distance range rendering them impractical for the coating system. A radar-based or ultrasonic-based system can measure the full depth of the tanks 140A-B. The tank agitators are triangular shaped and include a proximity switch to locate their position to allow for a clear line of sight for the radar or ultrasonic sensor to measure the composition surface depth in the respective tanks 140A-B. The radar or ultrasonic signal generators are mounted to the respective tanks 140A-B or the ceiling of the coating system housing. The monitoring system prevents a failure mode of running out of coating composition during a lining application by alerting the operators as to when additional composition can or should be added to each tank 140A and/or 140B. The coating system further includes an integrated bulk transfer system 130 for refilling the tanks 140A-B with full drums of the respective composition parts.

The bulk transfer system 130 is an automatic system that provides for increased volume transfer of the composition parts while reducing operator exposure to the composition parts. The two composition parts are sold in drum packaging (approximately 209 L or 55 gal.) weighing more than 272 kg (600 lbs.) each. Previously, the composition parts were delivered to tanks via mechanical or manual techniques such as by using a secondary composition handling vehicle that could include preconditioning capabilities or by emptying individual bags of composition (approximately 12 L each). Such techniques were sufficient since the compositions being transferred had lower viscosities and/or lower inorganic filler content. However, these techniques exposed both the operators and the composition chemistries to contamination.

The automatic transfer system 130 is programmed with the coating system's programmed logic controller (PLC) 195 to allow transfer of full drums of material. Because at least one composition part usually is a dispersion containing high amounts of inorganic fillers with low viscosity monomer components, that composition experiences syneresis of the material. With the dispersion being a solid in the drum, there isn't an efficient manner to shear the material and provide mixing in the drum before transfer to the tank 140A or B. Filling a tank 140A or B with only part of the drum's contents would result in alterations to the desired composition formulation in the tank 140A or B. For example, the composition blend in the tank 140A or B could become monomer rich or deficient. Thus, substantially all of the contents of the composition storage drums (a trace amount or residue of the compositions may remain) are transferred to the tanks 140A and B. To further ensure that as much of the full drum of material is transferred, the transfer system 130 includes drum unloaders having inflatable seals for each transfer drum. The seals inflate to contact the drum wall to prevent material from leaking/seeping over the top of the pump.

The integrated delivery system includes a motorized platform that holds two composition drum unloaders. The platform is integrated into the side of the coating system vehicle 110 and slides out, parallel to the ground, and lowers to the ground for drum replacement. Each of the drum unloaders is dedicated to a separate composition part such that cross-contamination of the compositions is reduced. This also eliminates the need for cleaning the pumps between fill operations. During transportation, the platform and drum unloaders are located within the coating system vehicle 110 so that they are always co-located with the coating system. Each drum unloader includes an inflatable seal and pump. The transfer system pumps operate at approximately 28.4 L (7.5 gal.) per minute. The integration of the transfer system with the coating system ensures that the transfer capability is co-located with the storage tanks 140A-B. The automation of the composition transfer to the tanks 140A-B reduces operator contact with the composition parts to increase operator safety and increase the consistency and integrity of the composition formulations.

Because at least one composition part of the two-part coating can experience syneresis, the mix ratios of the compositions are regularly checked throughout a coating process. For example, manual weight check stations are used to check the weight ratio of composition Part A to Part B at least three times daily as a verification of the mix ratio performance of a coating system, as determined by volumetric flow meters. However, the manual weight check stations involve a disruption in the fluid path for sampling the compositions, which can cause pressure disturbances and do not represent a sample at steady state. The manual check also creates a potential exposure for the operator as well as on-site disposal and contamination issues for the sampled material. The manual weight checks also require the operator to manually input the results which can incorporate human errors in the sampling, weighing, and recording of the data. Additionally, operators, knowing the required mixed weight ratio, could fabricate weight check data to avoid a stoppage in the coating process. The compositions must maintain a mixed weight ratio in a range of five percent of the target consistency to provide proper composition mixing and coating consistency. When a measured sample is outside the range, initiation of a coating process is delayed or a coating process is stopped.

In order to check the mix weight ratios in the coating system 100, mass flow meters 160A-B are included, one corresponding to each tank 140A-B. The mass flow meters 160A-B are integrated into the preconditioning long circuits by being plumbed in on an auxiliary flow circuit. Since mass flow meters 160A-B have a pressure limitation for proper function, the auxiliary circuit is isolated from the long circuits but is accessible from the exterior of the vehicle 110. This protects the mass flow meters 160A-B from damage and prevents unnecessary wear on the internal components of the meters 160A-B that can result from the highly inorganic filled chemistries. The mass flow meters 160A-B avoid the use of manual weight checks.

The composition parts are pumped through the coating system, including the umbilical hose, with a high capacity metering pump 155. Also, each composition storage tank 140A-B has a corresponding, dedicated transfer pump 150A-B. Existing coating systems typically use air driven pumps and low pressure hoses to achieve up to 12 L/min flow rates during coating applications. However, increasing coating caliper projects for structural coatings on increasing diameter pipes require increased coating efficiency. Therefore, pump 155 is a hydraulic driven pump utilizing high pressure hosing to deliver pump rates as high as 24 L/min during coating applications.

Pumps 150A-B pump the composition parts from storage tanks 140A-B to the metering pump 155, which then delivers the composition parts to the umbilical hose delivery system 170 within the vehicle 110. The umbilical hose delivery system 170 includes rotary delivery ports 180A-B, an umbilical hose, an umbilical hose storage drum, and umbilical hose storage drum controllers. The composition parts are delivered to respective hoses within the umbilical hose via rotary delivery ports 180A-B.

The storage drum housing includes up to seven rotary union/port connections. Typical coating systems include a rotary union to service each of the following functions: Part A composition delivery, Part B composition delivery, larger air line for air motor operation on the composition applicator, heating fluid delivery, and heating fluid return. Umbilical hose delivery system 170 includes two additional rotary unions to supply energy (e.g., air) to pneumatic control valves on the Part A and Part B composition delivery lines, respectively. Each of the rotary ports can be the same size or differ in size depending on the space limitations of the coating system and the material delivered to the umbilical hose. The control valves remove the need for an operator to be present in the pit during the composition applicator launch step, reducing worker exposure to uncured resin as further discussed below in connection with FIG. 7. While the rotary ports can be stacked on a single side of the umbilical storage drum, one or more rotary ports can be located on the opposing side of the drum. For example, the umbilical hose delivery system can position five ports on a single side and two additional ports on the opposite side. These two opposing ports can deliver the composition parts to the umbilical hose. The separable port design allows for an efficient footprint within the vehicle 110.

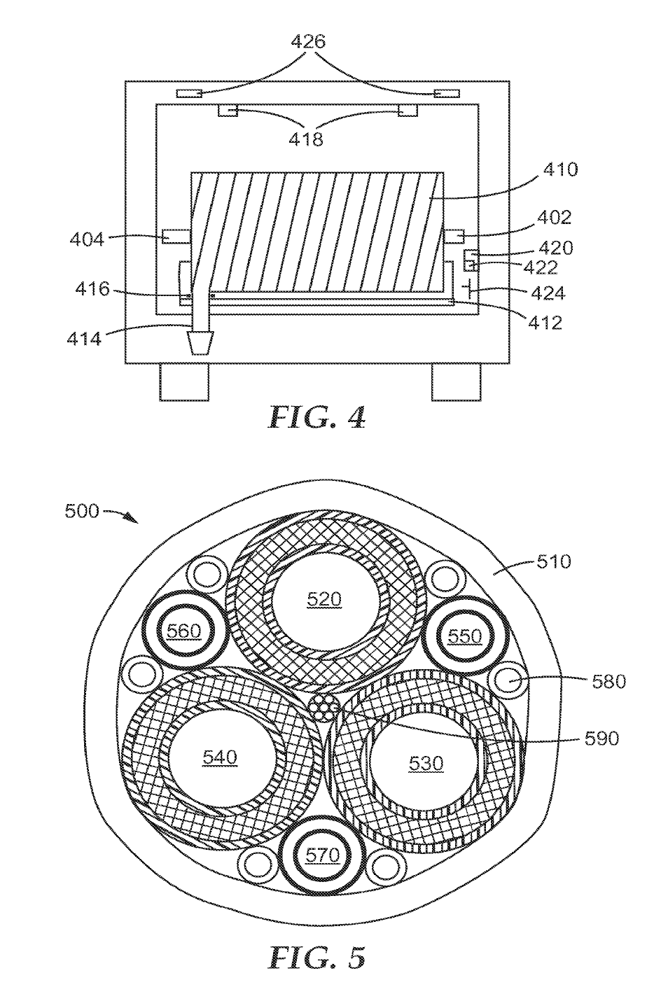

Each of the rotary ports couples to a hose included within the umbilical cord. For the above example of seven ports, the umbilical hose includes at least seven smaller diameter hoses. This relationship is further discussed below in connection with FIG. 5. A typical residential neighborhood lining project (e.g., a potable water pipeline lining project) involves a length of pipe less than 152 m (500 ft.). The coating system 100 includes an umbilical hose with a length up to 213.4 m (700 ft.) to allow the coating system 100 to address longer project lengths, such as those involving larger diameter transmission mains. The longer length of the umbilical increases the space limitations for storing the umbilical hose on a storage drum within vehicle 110. These design considerations are further discussed in connection with FIG. 4 below.

The coating system 100 includes several other features. For example, electrical panel 190 includes circuitry and valve control for the coating system 100 controls in vehicle 110. A PLC 195 is located at the rear of the vehicle 110 with access from the exterior of the vehicle and a view of the umbilical hose delivery from the vehicle 110. The PLC 195 controls pumping speeds, motor speeds, mass flow sampling times, volumetric flow sampling times, and records data for each aspect of the coating project. For example, the PLC 195 could record project data such as system pressures as well as environmental data such as ambient temperature, humidity, wind speed, project start and end times, as well as the operators facilitating the project. Several safety features are included such as pneumatic powered emergency wash stations located within the vehicle 110 and located accessible from the exterior of the vehicle. These are in addition to standard, large vehicle safety features required for operation of the vehicle.

To be qualified to be driven over the road, the above described vehicle 110 must meet transportation regulations such as maximum weight requirements. In the United States, this means that the vehicle must meet federal regulations (established by the U.S. Department of Transportation) as well as regulations for each of the individual fifty states, some of which are more stringent than the federal regulations. International transportation regulations must also be taken into account in the vehicle design for projects pursued outside the United States.

To meet the current weight requirements, the structural components of the vehicle 110 supporting the coating system are constructed of aluminum. In addition, the weight distribution within the vehicle 110 and the supporting structure is regulated by law. For example, the axle placement can interfere with the location of components at the rear of the vehicle 110 and affect the overall length of the vehicle 110. In addition, the vehicle 110 must meet hazardous material transport regulations including proper labeling and storage.

FIG. 2A illustrates a driver's side view of the exterior of a coating system incorporated into a vehicle 210. The vehicle 210 includes a cab 220 for a driver/operator of the coating system. The exterior provides various access points to the coating system. For example, ventilation panel 230 provides air flow for the coating system power source. The ventilation panel 230 can provide inflow or outflow for the power source in combination with a corresponding panel on the opposing side of the vehicle 210. The ventilation panel also provides heat dissipation for the power source. Door 240 provides an access point for an operator to enter the interior of the vehicle 210 to monitor and adjust aspects of the coating system. For example, door 240 is located adjacent an electrical panel and provides direct access to composition storage tanks. Although not shown, the vehicle can include any number of additional access points. For example, an access panel may be located near the rear of the vehicle to provide access to an umbilical hose storage system.

FIG. 2B similarly illustrates a driver's side view of the exterior of a coating system. However, the coating system is incorporated into a removable trailer 250. The trailer is attached to another mode of transport such as a flatbed truck or truck cab 260. The exterior access points of the trailer can be the same as, or differ from, those of the integrated vehicle of FIG. 2A. While the functional components of the coating system will also be consistent with the integrated vehicle, the location of those components may differ due to the structural differences introduced by the trailer configuration. For example, less underdeck storage may be available with the trailer. Also, the location of the rear axle(s) on the trailer may dictate the location of an umbilical storage drum—the weight of the drum must be supported while the entire circumference of the drum with the entire length of the umbilical hose wound onto the drum must fit within the floor, walls, and ceiling of the trailer. Incorporating the coating system into a removable trailer also increases the transportation options for delivering the coating system to different project sites (e.g., allows for a replacement mode of transport when there is a mechanical failure in a towing vehicle, different towing vehicles can handle different terrain, additional trailers can be connected, etc.).

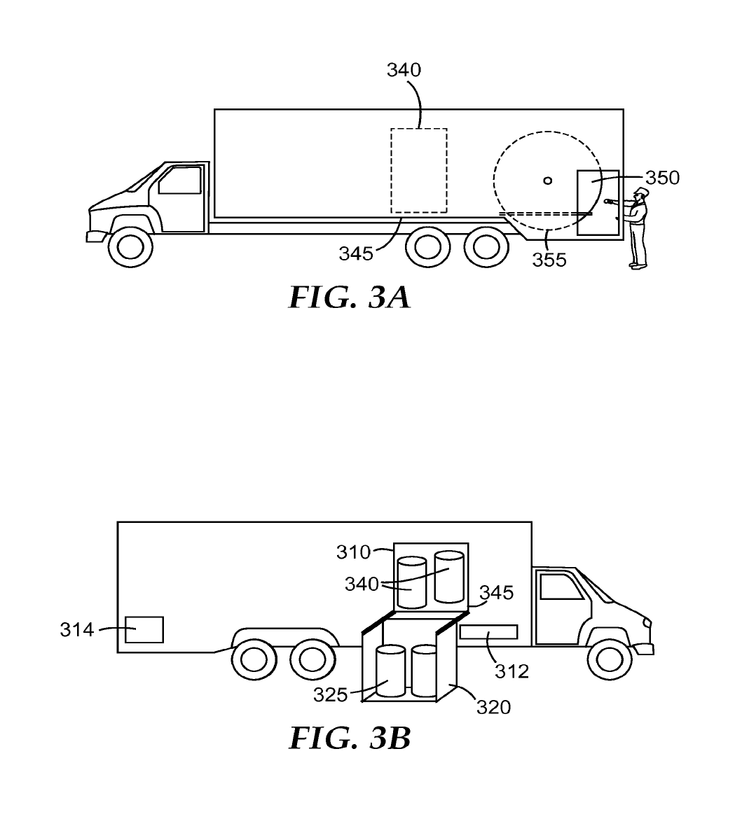

FIG. 3A illustrates a cross section of the driver's side of a coating system incorporated into a trailer. The components of the coating system are located similar to the discussion above in connection with FIG. 1. However, the cross-section illustrates the height relationship between an umbilical hose storage drum 350 and composition storage tanks 340. Previous coating systems locate an umbilical storage drum on a flat bed truck resulting in a need for access steps and/or safety rails for fall protection as operators work around the drum. Regardless of whether the coating system is incorporated into a vehicle or housed in a removable trailer, the rear of the housing in disclosed embodiments includes a lowered deck for operator access to the umbilical hose. The umbilical storage drum is positioned so the horizontal surface of the drum at a lowest point in the drum rotation 355 is on a plane lower than a plane of a bottom surface of the storage tanks 345. In the integrated vehicle, this positioning reduces the standard I-beam lengths. The lowered umbilical drum and corresponding exterior deck includes incorporating a cantilevered umbilical drum. This provides delivery of the umbilical hose at a more convenient height for an average height human operator. For example, the umbilical hose may be delivered from the drum at a 0.76 m (2.5 ft.) working level height from the vehicle deck while maintaining a ten degree departure angle from the vehicle.

FIG. 3B illustrates an external side view of the passenger side of a coating system incorporated into a vehicle. The side of the vehicle includes an access door 310 for a composition bulk transfer system. In FIG. 3B, access door 310 is open revealing the composition storage tanks 340 inside the vehicle with the bulk transfer system in an operational position with a platform 320 resting on the ground next to the vehicle. The platform 320 holds composition drums 325 and drum unloading equipment (not shown). A hydraulic lift system raises and lowers platform 320 between ground level and the inside floor of the vehicle 345 supporting the storage tanks 340. The hydraulic system also slides the platform horizontally in and out of the vehicle. When the bulk transfer system is not in use (e.g., when the vehicle is moving), platform 320 and the components of the bulk transfer system are positioned inside the vehicle next to the storage tanks 340.

In addition to access door 310, the exterior of the vehicle includes additional access points to portions of the coating system. For example, storage area 312 includes safety equipment (e.g., a pneumatic eye wash station) readily available to an operator working with the composition bulk transfer system. At the rear of the vehicle, access panel 314 protects the user interface of the coating system's PLC. The PLC includes a touch screen, or other user interface, for entering data and control parameters for operation of the coating system. The PLC stores the operational data in memory and can also include a printer to provide a physical copy of project data. An operator monitoring the PLC can also monitor the delivery/retraction of the umbilical hose at the rear of the vehicle.

FIG. 4 is a rear view of the coating system illustrating the umbilical drum 410 and related components. When a coating system is not in use, an umbilical hose 414 is wound around umbilical drum 410 for storage. When the coating system is in use, the umbilical hose is fed from the coating system to the project site (e.g., through a pipeline) through a guide 416 on screw drive 412. Due to the size and weight of the umbilical hose 414, the umbilical hose 414 must be wound tightly, with minimal slack or spacing between the coils, on the umbilical drum 410. If the winding is misaligned (e.g., overlap in the umbilical hose 414 coils), the umbilical hose 414 will not fit inside the coating system around the umbilical drum 410. For example, the coils will abut the ceiling of the coating system housing. The weight of the umbilical hose 414 prevents simple, manual realignment of the coils. Therefore, the screw drive 412 ensures proper winding and storage of the umbilical hose 414 during coating preparation and operation.

The screw drive 412 has three modes of operation: automated, mechanical, and manual. In automated mode, the guide 416 automatically slides back and forth along the screw drive 412. The guide 416 includes guide assemblies as well as one or more encoders and a roller. The umbilical hose 414 is guided onto (or off) the umbilical drum 410 as the drum 410 rotates. Once the hose 414 completes a coil around the drum 410, the guide 416 slides over a predetermined amount to position the hose 414 for forming a subsequent, adjoining coil. When the guide 416 reaches the end of the screw drive 412 and the corresponding end of the drum 410, the guide 416 reverses direction and repeats the winding process. The bi-directional, back and forth movement along the screw drive 412 continues until the umbilical hose is completely retracted from the project site and stored on the umbilical drum 410. The movement of the guide 416 is aided by laser monitoring system 418. The laser monitoring system 418 analyses the depth of umbilical hose 414 present on the drum 410, which in turn dictates the direction of the guide 416. When the guide 416 reaches the edge of the drum 410, a limit switch reverses the direction of travel for the guide 416. Laser monitoring system 418 helps alert the operator to any misalignments or discrepancies in the umbilical winding process so that the error can be corrected and the coating process continued with minimal disruption.

When the automated screw drive experiences an error in the winding of the umbilical on the drum, the screw drive can be switched to a mechanical mode. In mechanical mode, the guide 416 reverses direction mechanically, e.g., via an operator using a pendulum controller. This mode operates as a back-up, or fail-safe, to the laser monitoring system 418 of the automated mode. The coating system further includes a hand-crank 424 for an operator to maintain the drum rotation if the automated and/or mechanical modes falter. All three of the umbilical hose retraction modes are included in the coating system to increase the likelihood of an uninterrupted lining experience. The guide 416 can be positioned so that the umbilical hose is delivered from the drum at a 0.76 m (2.5 ft.) working level height from the vehicle deck while maintaining a ten degree departure angle from the vehicle. While the umbilical hose 414 is illustrated as exiting the vehicle from the top of the umbilical drum 410, the hose can also be configured to exit from the bottom of the umbilical drum 410.

In addition to the umbilical hose retraction control, the coating system includes a dual encoder system to control the umbilical drum rotation speed. A first, umbilical hose encoder is wheel mounted to the guide 416 of the screw drive 412 in intimate contact with the umbilical hose 414 to measure the travel speed as it is retracted from (or extended to) a project site. The signal of the first encoder is sent to a PLC which combines retraction speed data with the composition volumetric flow rate to control the drive motor speed for the umbilical drum drive 420. However, inconsistencies in the umbilical retraction speed (e.g., caused by uneven retraction due to obstructions or deviations in the pipeline being coated or due to complications in winding the umbilical hose on the umbilical drum) result in frequent alterations to the umbilical drive motor. The size of the umbilical drum and the signaling time cause delays in the drum drive control. For example, by the time the drum drive motor reacts to a slowing speed of hose retraction, the retraction speed can have already corrected causing unnecessary alterations to the drum rotation. A second, drum drive, encoder 422 is incorporated into the drum drive 420 to avoid these delays. The second encoder 422 provides the measured drive shaft speed directly to the PLC. Thus, the PLC can evaluate the real-time drive shaft speed in connection with the umbilical retraction speed to provide more accurate control of the umbilical drum 410. The speed control combined with the composition volumetric flow rate provides for accurate delivery of the proper coating caliper to the pipeline interior.

The rear of the coating system also provides operator access to the interior of the housing. For example, an operator can access the umbilical hose ports 402, 404. The rear access is accessible through an overhead roll up door. Other door styles can also be used; however, the roll up door keeps the door out of the umbilical drum work area and away from the operator(s). The coating system housing also includes adjustable lights 426. These lights illuminate the umbilical drum work area, as well as the project site entry point for projects beginning or ending with diminished natural lighting or when working in inclement weather.

Details of an umbilical hose 500, which is an embodiment of umbilical hose 414, are illustrated in FIG. 5. Umbilical hose 500 is a first hose encasing a plurality of hoses 520, 530, 540, 550, 560, 570, and 580. Umbilical hose 500 includes a casing 510 having an internal diameter larger than the outer diameters of each the plurality of hoses 520, 530, 540, 550, 560, 570, and 580. Casing 510 is made of extruded polyurethane and ranges in thickness from 0.64 cm (0.25 in.) to 2.5 cm (1.0 in.) thick. For example, casing 510 is extruded over a hose bundle containing hoses 520, 530, 540, 550, 560, 570, and 580. A typical outer diameter for the umbilical hose is 7.06 cm (0.23 ft.) yielding a bend radius of about 0.4 m (1.4 ft.).

While the plurality of hoses 520, 530, 540, 550, 560, 570, and 580 can have the same diameters, this is not necessary. The illustrated, larger diameter hoses 520 and 530 are each used to deliver one of the coating compositions (Part A and Part B). These hoses 520, 530 are reinforced and have an internal diameter of about 0.02 m (0.06 ft.). Another larger diameter hose 540 delivers air for operating an air motor in the composition applicator. The air delivery line 540 has an inner diameter of about 0.02 m (0.06 ft.). Smaller diameter hoses (inner diameter approximately 0.006 m or 0.02 ft.) 550, 560, 570 deliver additional fluids through the umbilical hose 500. For example, hose 550 delivers heating fluid through the umbilical hose and hoses 560 and 570 return the heating fluid to the coating system. The heating fluid maintains the temperatures of the composition parts through the extended length of the umbilical hose 500. Hose 580 can be used to deliver energy to control valves on the composition supply hoses 520, 530. Hose 580 can be a single hose that splits at the distal end of the umbilical hose to supply energy to the two control valves. Alternatively, another hose similar to hose 580 is included in the umbilical hose 500 so that each control valve is serviced by a separate energy supply hose. Due to the volumetric flow rates of the respective compositions for higher caliper coating projects and the respective hose diameters, the hoses 520 and 530 can withstand pressures of 5,000 psi.

In addition to the functional hoses described above, the umbilical hose 500 includes filler tubing. These lines do not carry fluids through the umbilical hose, but are present to shape and support the umbilical casing 510. The number of filler tubes can vary depending on the number of functional hoses present in the umbilical hose 500. The umbilical hose further includes a wire rope 590 located approximately in the center of the umbilical hose. Wire rope 590 provides support for the umbilical hose 500. Also, wire rope 590 is used for positioning the umbilical hose 500 in a pipeline at a project site. The umbilical hose 500 not only delivers the composition parts to the composition applicator, it also acts as a component of the preconditioning process for the coating system.

FIG. 6 illustrates the composition flows within the coating system. The composition parts (e.g., Part A and Part B) are stored in respective tanks 640A and 640B. To precondition the compositions and the coating system, the composition parts are heated and circulated through one or more circuits in the coating system. First, the composition parts are agitated and heated in the storage tanks 640A and 640B. To induce shear into the coating system and begin to decrease viscosity in the composition lines, the respective composition parts are pumped through respective short circuits 630A and 630B. To continue to ensure thorough blending and establish a steady state, the composition parts are next routed through respective long circuits 660A and 660B. The long circuits 660A-B include pumping the composition parts through the length of the umbilical hose 620 while it is stored on the umbilical drum 610 before being routed back to the tanks 640A-B.

In coating systems, there are several design considerations including the maximum volumetric flow rate. For small diameter composition hoses, e.g., diameters ≦1.90 cm (0.75 in.), the maximum volumetric flow rate is dictated by the maximum operating pressure that can be achieved based on the parameters of pumping capacity, hoses, and the coating viscosity of the chemical composition. Most portable coating system designs for in-situ pipe rehabilitation were based on air driven pumping systems and hoses with diameters ≦1.90 cm (0.75 in.). These low pumping capacity systems demanded the use of a short circuit path for composition conditioning and start-up.

Embodiments of the disclosed coating systems use hydraulic metering pumps and corresponding high pressure tubing with larger diameters. Therefore, the surface to volume ratios of the composition hoses are larger resulting in the disclosed embodiments having higher volumetric flow rates, while reducing the overall steady state system pressure. These larger diameter hoses, e.g., diameters ≧1.90 cm (0.75 in.), effectively decouple the volumetric flow rate from the system pressure as a limiting factor. That is, high flow rates can be maintained at low pumping pressures. The useful maximum volumetric flow rate is no longer restricted by the maximum operating pressure of the hoses or pumping system. Now the ability for the coating head apparatus to receive and deliver the multi-part composition to the pipe wall becomes the volumetric flow rate determining step. Effectively, the larger diameter hoses in combination with the hydraulic pumping system deliver as much composition to the coating head as the coating head technology currently allows.

This lower overall system pressure allows for a start-up process that eliminates preconditioning with the short circuits 630A-B. Thus, the short circuit lines 630A-B are optional in that they may not be used during start-up or even included in the coating system. Other circuits that are used selectively include safety circuits 650A-B. These lines are actuated when a problem, e.g., excess pressure buildup or inaccurate composition weight mix ratios, occurs downstream in one or more of the long circuits 660A-B. Safety circuits 650A-B allow for pressure release and a return of the respective compositions to the storage tanks 640A-B.

Downstream from storage tanks 640A-B, volumetric flow meters record the flow rates of the respective compositions. However, once the compositions enter the umbilical hose 620, the flow can no longer be monitored unless the composition returns to the tanks 640A-B during long circuit preconditioning. Thus, mass flow meters 670A-B are included in the return lines of the long circuits 660A-B. The mass flow meters act as a proxy for the conditions at the composition applicator 680 and provide an accurate measurement of the respective compositions at the end of the umbilical hose 620/composition applicator 680. To protect the mass flow meters from pressure build-up in the long circuits 660A-B (mass flow meters can only handle pressures up to 1500 psi), the mass flow meters are plumbed on isolated circuits. The mass flow meters 670A-B are positioned to be accessible from the exterior of the coating system housing and are controlled by the PLC. The preconditioning process allows for more accurate formulations of the Part A and Part B compositions at the end of the umbilical hose 620 thereby resulting in a more accurate mixed multi-part coating composition being applied.

FIG. 7 illustrates an example method for initiating delivery of a two-part coating composition for in situ coating an internal pipeline surface. The method begins by positioning the umbilical hose and a composition applicator at the pipeline 710. Positioning involves pulling a distal end of the umbilical hose from a lining rig through the pipeline and attaching the composition applicator to the distal end of the umbilical hose. The umbilical hose includes at least two composition supply hoses within the umbilical hose, where each composition supply hose supplies one part of the two-part coating composition. The composition applicator can be any variety of applicator including a conical, rotational spray applicator. The umbilical hose also includes at least two taps. The first tap is coupled to the first composition supply hose. Likewise, a second tap is coupled to the second composition supply hose. The energy can be supplied in the form of compressed air, compressed water, or electricity, and the supply hoses can also be included within the umbilical hose.

Once the umbilical hose and composition applicator are positioned in the pipeline, operation of the lining rig is initiated 720. Operation of the rig involves delivering, e.g., pumping, a first composition (Part A) to the composition applicator via the first composition supply hose and delivering, e.g., pumping, the second composition (Part B) to the composition applicator via the second composition supply hose. After a predetermined amount of time (e.g., 30 seconds) or when a predetermined amount of pressure has built at the distal ends of the composition supply hoses, the composition applicator is actuated 730. Operation of the composition applicator includes initiating rotation of the spray cone (for a rotational spray applicator) and actuating the first and second taps to supply both parts of the two-part composition to the applicator.

The two compositions are separately stored within the lining rig and separately supplied to the composition applicator. Thus, the two compositions are combined in the composition applicator 740. For example, the two compositions are statically mixed in the composition applicator just prior to application to the pipeline internal surface. The combined compositions are then applied to the internal pipeline circumferential surface 750. Application can be performed with a variety of techniques including rotational spraying, as is known in the art.

As discussed above, initiating the coating process includes manual intervention. For example, a lining technician enters the pit at the distal end of the pipeline to extract the umbilical hose and manually attach the composition applicator. The technician waits until the compositions are pumped to the distal end of the umbilical hose to manually open the taps on the composition supply hoses. Alternatively, after manually attaching the composition applicator to the umbilical hose, the umbilical hose is retracted into the pipeline so that the taps are positioned within the pipeline. An operator located at the proximal end of the pipeline/lining rig triggers the rig control circuitry to supply energy (via separate energy supply lines) to control valves on the energy supply lines. The control valves are coupled to the taps such that the taps can be remotely actuated from the lining rig. The operator also remotely initiates the composition applicator motor. In another embodiment, the technician at the distal end of the umbilical hose can remotely actuate the control valves and/or taps via wireless control. After either a manual or remote start-up of the composition feeds to the composition applicator, the lining technician collects the first effluent for composition analysis. The applicator is retracted through the pipeline at a predetermined rate to apply the composition to the length of the pipeline.

The method is applicable to larger volume composition coating projects involving various lining thicknesses, pipe lengths, and pipe diameters. For example, an internal circumferential pipeline surface can be lined at a thickness of at least 5 mm to 183 m (600 ft.) of pipeline in a single pass. The internal pipe diameter for such a project can be 0.3-0.6 m (1-2 ft.), and the application can be completed in two hours or less. The method can further be used to apply the two-part composition at a thickness of 8 mm with the same pipe dimensions and timing. Further, a two-part fast-setting polyurea chemistry with a gel time of approximately forty seconds can be applied at a caliper of up to 8.5 mm on a 0.6 m (2 ft.) pipe internal diameter in less than two hours. While the above lining thicknesses are obtained using a single pass technique, additional passes can provide increased thicknesses.

### EXAMPLES

Coating rigs were assembled according to the disclosure. The components were characterized via the following test procedures to establish flow rate and resin coat caliper or thickness.

### Test Methods

### Flow Rate

Flow rate was determined using a calibrated set of flow meters connected to an Allen Bradley Panel View Plus 700 programmable logic controller (PLC), obtained from Rockwell Automation Inc, Milwaukee, Wis. Two VSE Precision Flow Meters Model VS 1 available from IC Flow Controls, Inc. Normal, Ill. measured flow rate on the first and second part resin lines. The volumetric flow rate from the first part line and the measurement from the second part line were summed together and reported as a combined total flow rate. Volumetric flow rate was recorded at the PLC every second and reported every 6 seconds during a lining trial. Air motor operation was calibrated to 10,000 rpm prior to the introduction of composition. Air motor operation fluctuated between 7,000 and 8,000 rpm during composition application.

### Caliper Test

The process for determining the thickness of the resin coated in the pipe by the in-situ applicator was performed as follows. A 2.4 meter (8 ft.) section of polyvinyl chloride (PVC) pipe was coated with resin and allowed to cure for one hour. The coated PVC pipe was cross-sectioned cut at 0.6 m (2 ft.) and 1.8 m (6 ft.) from the end of the pipe. The coating was removed from the pipe. An Absolute Digimatic Caliper from Mitutoyo America Corp, Aurora, Ill. was used to measure the caliper, or thickness, of the resin coating around the circumference at twelve hour hand intervals.

### Example 1

### Single Pass Caliper

Caliper of an applied liner was determined by coating a 2.4 m (8 ft.) length of pipe and cutting the pipe into two cross sections at 0.6 m (2 ft.) and 1.8 m (6 ft.). The liner was applied in a single pass to a pipe with an outer diameter of 0.45 m (1.5 ft.). The outer cone diameter of the spray applicator was 70 mm and the inner cone diameter was 35 mm. Flow rate and lining speed measurements were recorded and are summarized in Table 1 along with other test characteristics.

TABLE 1
Single Pass Caliper

| Characteristic | E1 |
|---|---|
| Pipe Type | Polyvinyl Chloride (PVC) |
| Pipe Length (meters) | 2.40 |
| Pipe Outer Diameter (meters) | 0.45 |
| Average Flow Rate (liters per minute) | 15.55 |
| Average Lining Speed (meters per minute) | 1.71 |
| Targeted Caliper (mm) | 6.50 |

Twelve caliper measurements were recorded around the circumference of the pipe at hour hand intervals for an in-situ applicator with a three-outlet diverter cone. Results are summarized in Table 2.

TABLE 2
Single Pass Caliper

Location

| | 0.6 m (2 ft.) | 1.8 m (6 ft.) |
|---|---|---|
| Hour Hand Clock Position | Caliper (mm) | Caliper (mm) |
| 12 | 6.50 | 7.06 |
| 1 | 6.44 | 7.44 |
| 2 | 6.40 | 6.46 |
| 3 | 6.22 | 6.32 |
| 4 | 6.19 | 6.48 |
| 5 | 6.31 | 6.77 |
| 6 | 5.98 | 6.69 |
| 7 | 6.39 | 7.04 |
| 8 | 6.08 | 6.90 |
| 9 | 6.28 | 6.74 |
| 10 | 6.70 | 7.10 |
| 11 | 6.79 | 7.04 |
| Average Caliper (mm) | 6.36 | 6.84 |

### Example 2

### Automatic Composition Transfer System

Timing of composition transfer into the tanks was calculated by determining the amount of time required to distribute 152 L (40 gal.) of a composition from a drum or pail into a tank. The automatic composition transfer system, controlled by the Allen Bradley Panel View Plus 700 programmable logic controller (PLC), emptied 152 L (40 gal.) of a 209 L (55 gal.) drum of composition in six minutes. A single person manually reloading the tank distributed thirteen pails of the composition, each at twelve liters, in 52 minutes. Two people manually reloading the tank reduces the time to 35 minutes. The automatic composition transfer system is five to eight times more efficient at moving material.

Following is a list of embodiments of the present disclosure.

Item 1 is a portable delivery system for delivering a multiple part coating composition for in situ coating an internal pipeline surface, comprising:

a housing comprising:
a controller;
at least two composition containers, including a first and a second composition container, configured to contain differing compositions, each container including a composition depth monitoring apparatus;
a first hose having a first diameter and comprising at least two additional hoses each having a diameter smaller than the first diameter within the first hose, each of the at least two additional hoses being configured to deliver one of the at least two compositions to a composition applicator;
a hose delivery system configured to store and deliver the first hose to the pipeline;
a pump coupled to the at least two composition containers and the first hose; and
at least two mass flow meters including a first mass flow meter coupled to a first pump outlet corresponding to an outlet of the first composition container and a second mass flow meter coupled to a second pump outlet corresponding to an outlet of the second composition container.
   Item 2 is the system of item 1, wherein the housing is at least one of: incorporated into a vehicle and configured to attach to a vehicle.
   Item 3 is the system of item 1, wherein the system further comprises an automatic composition transfer system configured to load the at least two composition containers.
   Item 4 is the system of item 3, wherein the automatic composition transfer system is configured to transfer substantially all of a first composition stored in a first storage container to the first composition container and to transfer substantially all of a second composition stored in a second storage container to the second composition container.
   Item 5 is the system of item 1, wherein the pump is configured to deliver the at least two compositions through the at least two additional hoses at, at least ten liters per minute.
   Item 6 is the system of item 1, wherein the at least two mass flow meters are coupled to the first and second pump outlets in respective isolation circuits.
   Item 7 is the system of item 1, wherein the composition depth monitoring apparatus is at least one of a radar apparatus and an ultrasonic apparatus.
   Item 8 is the system of item 1, wherein the hose delivery system includes a bi-directional screw drive system configured to be controlled automatically via the controller, manually in combination with a second controller, and manually with a hand crank.
   Item 9 is the system of item 1, wherein the hose delivery system includes a horizontally positioned drum, rotatable about a center axis, around the horizontal exterior of which the first hose is stored, wherein the horizontal surface of the drum at a lowest point in the rotation is positioned on a plane lower than a plane of a bottom surface of the at least two composition containers.
   Item 10 is the system of item 1, wherein the hose delivery system includes a drum drive system and the drum drive system is configured to rotate the drum bi-directionally.
   Item 11 is the system of item 1, wherein the hose delivery system includes a first encoder configured to measure the length of the first hose delivered and a hose delivery speed and a second encoder configured to control speed of a drum drive system, the second encoder being responsive to the first encoder.
   Item 12 is the system of item 1, wherein the hose is at least 183 m in length.
   Item 13 is the system of item 1, wherein the housing further comprises a power source.
   Item 14 is a portable delivery system for delivering a multiple part coating composition for in situ coating an internal pipeline surface, comprising:

a housing comprising:
a controller;
at least two composition containers configured to contain differing compositions;
a first hose having a first diameter and comprising at least six additional hoses each having a diameter smaller than the first diameter within the first hose, two of the at least six additional hoses being configured to deliver a respective one of the at least two compositions to a composition applicator;
a hose delivery system configured to store and deliver the first hose to the pipeline, the hose delivery system comprising at least six ports; and
a pump coupled to the at least two composition containers and the first hose.
   Item 15 is the system of item 14, wherein the housing is at least one of: incorporated into a vehicle and configured to attach to a vehicle.
   Item 16 is the system of item 14, wherein the system further comprises an automatic composition transfer system configured to load the at least two composition containers.
   Item 17 is the system of item 16, wherein the automatic composition transfer system is configured to transfer substantially all of a first composition stored in a first storage container to the first composition container and to transfer substantially all of a second composition stored in a second storage container to the second composition container.
   Item 18 is the system of item 14, wherein each of the at least two composition containers further comprises a composition depth monitoring apparatus.
   Item 19 is the system of item 18, wherein the composition depth monitoring apparatus is at least one of a radar apparatus and an ultrasonic apparatus.
   Item 20 is the system of item 14, wherein the system further comprises at least two mass flow meters including a first mass flow meter coupled to a first pump outlet corresponding to an outlet of the first composition container and a second mass flow meter coupled to a second pump outlet corresponding to an outlet of the second composition container.
   Item 21 is the system of item 20, wherein the at least two mass flow meters are coupled to the first and second pump outlets in respective isolation circuits.
   Item 22 is the system of item 14, wherein the hose delivery system includes a bi-directional screw drive system configured to be controlled automatically via the controller, manually in combination with a second controller, and manually with a hand crank.
   Item 23 is the system of item 14, wherein the housing further comprises a power source.
   Item 24 is the system of item 14, wherein the hose delivery system includes a horizontally positioned drum, rotatable about a center axis, around the horizontal exterior of which the first hose is stored, wherein the horizontal surface of the drum at a lowest point in the rotation is positioned on a plane lower than a plane of a bottom surface of the at least two composition containers.
   Item 25 is the system of item 14, wherein the hose delivery system includes a drum drive system and the drum drive system is configured to rotate the drum bi-directionally.
   Item 26 is the system of item 14, wherein the hose delivery system includes a first encoder configured to measure the length of the first hose delivered and a hose delivery speed and a second encoder configured to control speed of a drum drive system, the second encoder being responsive to the first encoder.
   Item 27 is a method for initiating delivery of a two part coating composition for in situ coating an internal pipeline surface comprising:

pulling a distal end of an umbilical hose comprising a first and a second composition supply hose from a lining rig through the pipeline and attaching a composition applicator to the distal end, wherein the umbilical hose includes at least two taps, a first tap coupled to the first composition supply hose and a second tap coupled to the second composition supply hose;

initiating operation of the lining rig comprising delivering a first composition to the composition applicator via the first composition supply hose and delivering a second composition to the composition applicator via the second composition supply hose;

actuating the composition applicator comprising actuating the first and second taps;

combining the first and second compositions in the composition applicator; and

applying the combined first and second compositions to the internal pipeline circumferential surface at a thickness of at least 5 mm to 183 m of pipeline in a single pass.

Item 28 is the method of item 27, further comprising:

supplying energy via a first supply hose to a first control valve coupled to the first tap and supplying energy via a second supply hose to a second control valve coupled to the second tap;

retracting the umbilical hose to position the at least two control valves within the pipeline; and

actuating the composition applicator by actuating the first and second control valves from the lining rig.

Item 29 is the method of item 28 wherein supplying energy to the first and second control valves comprises at least one of supplying compressed air, supplying compressed water, and supplying electricity.
Item 30 is the method of item 27, wherein applying the combined first and second compositions comprises applying the combined compositions in two hours or less.
Item 31 is the method of item 27, wherein applying the combined first and second compositions comprises applying the combined compositions to a pipeline having an internal diameter of 0.3-0.6 m.
Item 32 is the method of item 27, wherein the first and second compositions are statically mixed in the composition applicator.
Item 33 is the method of item 27, wherein the combined first and second compositions are applied to the internal pipeline circumferential surface at a thickness of at least 8 mm.

Unless otherwise indicated, all numbers expressing quantities, measurement of properties, and so forth used in the specification and claims are to be understood as being modified by the term “about.” Accordingly, unless indicated to the contrary, the numerical parameters set forth in the specification and claims are approximations that can vary depending on the desired properties sought to be obtained by those skilled in the art utilizing the teachings of the present application. Not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, to the extent any numerical values are set forth in specific examples described herein, they are reported as precisely as reasonably possible. Any numerical value, however, may well contain errors associated with testing or measurement limitations.

Various modifications and alterations of this disclosure will be apparent to those skilled in the art without departing from the spirit and scope of this disclosure, and it should be understood that this disclosure is not limited to the illustrative embodiments set forth herein. The reader should assume that features of one disclosed embodiment can also be applied to all other disclosed embodiments unless otherwise indicated. It should also be understood that all U.S. patents, patent application publications, and other patent and non-patent documents referred to herein are incorporated by reference, to the extent they do not contradict the foregoing disclosure.

1. A portable delivery system for delivering a multiple part coating composition for in situ coating an internal pipeline surface, comprising:
a housing comprising:
a controller;
at least two composition containers, including a first and a second composition container, configured to contain differing compositions, each container including a composition depth monitoring apparatus;
a first hose having a first diameter and comprising at least two additional hoses each having a diameter smaller than the first diameter within the first hose, each of the at least two additional hoses being configured to deliver one of the at least two compositions to a composition applicator;
a hose delivery system configured to store and deliver the first hose to the pipeline;
a pump coupled to the at least two composition containers and the first hose; and
at least two mass flow meters including a first mass flow meter coupled to a first pump outlet corresponding to an outlet of the first composition container and a second mass flow meter coupled to a second pump outlet corresponding to an outlet of the second composition container.

2. The system of claim 1, wherein the housing is at least one of: incorporated into a vehicle and configured to attach to a vehicle.

3. The system of claim 1, wherein the system further comprises an automatic composition transfer system configured to load the at least two composition containers.

4. The system of claim 3, wherein the automatic composition transfer system is configured to transfer substantially all of a first composition stored in a first storage container to the first composition container and to transfer substantially all of a second composition stored in a second storage container to the second composition container.

5. The system of claim 1, wherein the pump is configured to deliver the at least two compositions through the at least two additional hoses at, at least ten liters per minute.

6. The system of claim 1, wherein the at least two mass flow meters are coupled to the first and second pump outlets in respective isolation circuits.

7. The system of claim 1, wherein the composition depth monitoring apparatus is at least one of a radar apparatus and an ultrasonic apparatus.

8. The system of claim 1, wherein the hose delivery system includes a bi-directional screw drive system configured to be controlled automatically via the controller, manually in combination with a second controller, and manually with a hand crank.

9. The system of claim 1, wherein the hose delivery system includes a horizontally positioned drum, rotatable about a center axis, around the horizontal exterior of which the first hose is stored, wherein the horizontal surface of the drum at a lowest point in the rotation is positioned on a plane lower than a plane of a bottom surface of the at least two composition containers.

10. The system of claim 1, wherein the hose delivery system includes a drum drive system and the drum drive system is configured to rotate the drum bi-directionally.

11. The system of claim 1, wherein the hose delivery system includes a first encoder configured to measure the length of the first hose delivered and a hose delivery speed and a second encoder configured to control speed of a drum drive system, the second encoder being responsive to the first encoder.

12. (canceled)

13. The system of claim 1, wherein the housing further comprises a power source.

14-26. (canceled)

27. A method for initiating delivery of a two part coating composition for in situ coating an internal pipeline surface comprising:
pulling a distal end of an umbilical hose comprising a first and a second composition supply hose from a lining rig through the pipeline and attaching a composition applicator to the distal end, wherein the umbilical hose includes at least two taps, a first tap coupled to the first composition supply hose and a second tap coupled to the second composition supply hose;
initiating operation of the lining rig comprising delivering a first composition to the composition applicator via the first composition supply hose and delivering a second composition to the composition applicator via the second composition supply hose;
actuating the composition applicator comprising actuating the first and second taps;
combining the first and second compositions in the composition applicator; and
applying the combined first and second compositions to the internal pipeline circumferential surface at a thickness of at least 5 mm to at least 183 m of pipeline in a single pass.

28-33. (canceled)

34. The system of claim 1, further comprising volumetric flow meters which detect individual composition mix ratios in the containers

35. The system of claim 34, wherein the mass flow meters compensate for volumetric mix ratios measured at the volumetric flow meters.
